(19) United States
(12) Patent Application Publication
(10) Pub. No.: US 2009/0224168 A1
(43) Pub. Date: Sep. 10, 2009

(54) System for Measuring Ultraviolet Solar Radiation With Means for Displaying UV Information in a Public Place

(75) Inventors: Tomas Pablo Santibanez- Viani, Santiago (CL); Ernesto Vicente Gramsch-Labra, Santiago (CL)

Correspondence Address: ERIC HANSCOM, 7395 PORTAGE WAY, CARLSBAD, CA, 92011, US

(73) Assignee: TECCIA, LTDA., Santiago (CL)

(21) Appl. No.: 10/596,983

(22) PCT Filed: Dec. 23, 2004
(86) PCT No.: PCT/EP2004/014685

§ 371 Date: Mar. 4, 2009

(30) Foreign Application Priority Data
Jan. 5, 2004 (CL) 15.2004

(51) Int. Cl. G01J 1/42

(52) U.S. Cl. 250/372

(57) ABSTRACT

The present invention refers to a system and corresponding device to measure instantly and permanently the ultraviolet radiation with display adequate to be located in places visible by people and that allows to show the ultraviolet radiation detected in a panel, billboard or ad by means of the color code recommended by the world Health Organization such that the system comprises a head to detect the ultraviolet radiation, means to process the signal, and means to display such signal in a private or public place.

### TECHNICAL FIELD OF THE INVENTION

This invention relates to a system and its corresponding device to measure instantly and permanently the ultraviolet radiation with a display of the intensity of radiation or UV index by means of a color code and/or numerical symbols such that they can be installed in public places to be seen by people.

### BACKGROUND OF THE INVENTION

The sun emits naturally ultraviolet radiation (UV). There are also some manmade lamps and tools (welding tools, for instance) that can produce UV radiation. For most of us, however, the sun is the primary source of UV. UV is divided into at least three different categories based on wavelength:

UVA wavelengths (320-400 nm) are only slightly affected by ozone levels. Most UVA radiation is able to reach the earth's surface and can contribute to tanning, skin aging, eye damage, and immune suppression.
UVB wavelengths (280-320 nm) are strongly affected by ozone levels. Decreases in stratospheric ozone mean that more UVB radiation can reach the earth's surface, causing sunburns, snow blindness, immune suppression, and a variety of skin problems including skin cancer and premature aging.
UVC wavelengths (100-280 nm) are very strongly affected by ozone levels, so that the levels of UVC radiation reaching the earth's surface are relatively small.

The effects of UV radiation are severe on human health, animals and earth's ecosystems and all UV radiation can be damaging. This knowledge has prompted many manufacturers of sun screen and sunglasses to offer products that protect against both UVA and UVB wavelengths.

While humans can choose various courses of protection, for instance avoiding noon-time sun, plants and animals are not so fortunate. Studies have shown that increased UV radiation can cause significant damage, particularly to small animals and plants. Phytoplankton, fish eggs, and young plants with developing leaves are particularly susceptible to damage from overexposure to UV.

Presently, most industrialized countries of the world that are affected by high levels of ultraviolet (UV) radiation have measurements networks that provide information to the public. These networks are necessary because of the awareness that exists in these countries of the social and economic cost associated with ultraviolet radiation. For example, in United States of America there is a network that covers all territory, with 58 continuous monitoring stations that measure the UV index, the width of the ozone layer and make a prediction of the UV index for the next day, and the information is available through Internet. In addition, through this network, all kind of information is provided about the effects of UV radiation on the human health. The network also serves as a method to centralize the epidemiological studies of cancer and other related skin disorders. Many studies indicate that in United States, one in five persons will develop some kind of skin cancer during their life.

As in United States, in Australia, there exists an extensive measuring network that covers the whole country. In addition, there are many campaigns in schools and other institutions. The media (TV, radio and newspapers) covers extensively all topics related to the health risks of the UV radiation from the sun.

In New Zealand there is also an extensive network for measuring, education and prevention of the health effects of UV radiation. The National Institute for water and atmospheric research is in charge of the mentioned tasks. The UV index is measured continuously and the information is given daily to the community. The network has allowed New Zealand to obtain information about the increase in the UV radiation intensity in the last 20 years and correlate it with an increase with skin cancer.

As it was already mentioned, there are institutions in Chile that have been measuring UV radiation for several years, such as the University of Santiago, the University of Chile, Universidad Técnica Federico Santa Maria, the Meteorological Institute of Chile, etc. A national network has been established between these institutions leaded by the University of Santiago and CONAC (National Corporation for Cancer). The daily information is accessible through Internet (http://www.indiceuv.cl) as well as a prediction of the maximum for the next day.

However, there are several problems that preclude that the information available be very useful for the general public. The first problem is that all these are individual efforts, and they depend on the permanence of the investigator in the University. Second, because this is an individual effort, its coverage is very limited, and only people related with the University knows the information. For instance, the University of Chile has made measurements since 1990, but people has no access to that information. The second problem is that when the information is on line, it depends on the administrator. Many times the information is available only during weekdays, because the cost of keeping and operator during the weekends to put the information on the Internet is too high. This problem does not allow to have a large number of monitoring stations. The third problem is that there is no uniform standard for calibration or to display the information.

It has to be noted that there are no standard predictive models for solar UV radiation, that mean that the predictions can only be made from one day to another. All long-term predictions are not very accurate. This fact does not allow comparison between predictions from different entities. Furthermore, because there are no recognized prediction standard, people is exposed to large errors in the results of the prediction.

The present invention gives an answer to some the mentioned problems by providing a system and its corresponding device to monitor and display the UV radiation in public places. The possibility that system and its corresponding device can be installed in public places gives the option to let many people know about the UV radiation at the same time. With the information being updated every instant, and showing the variability during the different hours of the day. In addition to the benefits for the health of people, another advantage of the system is that it would enhance any public advertising by attracting the attention of people, which is attractive for the companies. Thus, there are two benefits for the advertisers; one is the greater penetration in the people, and the other is that because the system is associated to a free public service, people will have a more friendly perception of the products offered. However, the system is not necessarily associated with advertising.

In addition, the system is so versatile that it can be implemented in a variety of places or situations. Not only it can be placed in public ads, but it is possible to locate inside buildings, such as malls, closed stadiums, cines, even in the subway, as long as the UV sensor head is located nearby facing the sun.

In what follows there is a detailed description of the invention with figures.

### BRIEF DESCRIPTION OF THE FIGURES

FIG. 1. Block diagram of the main components of the system and corresponding device to measure and display the ultraviolet radiation.

FIG. 2. Schematic representation of the sensor head that measured the UV radiation.

FIG. 3. Schematic representation of the electronic circuit inside the sensor head.

FIG. 4. Graph of the erythema action spectral response that is required for the detector/filter combination.

FIG. 5. Graph of the spectral response of a SiC semiconductor detector (short dash) and a SiC with a UV-B filter (continuous line)

FIG. 6. Example of an application of the invention to commercial advertising in a panel or large public sign

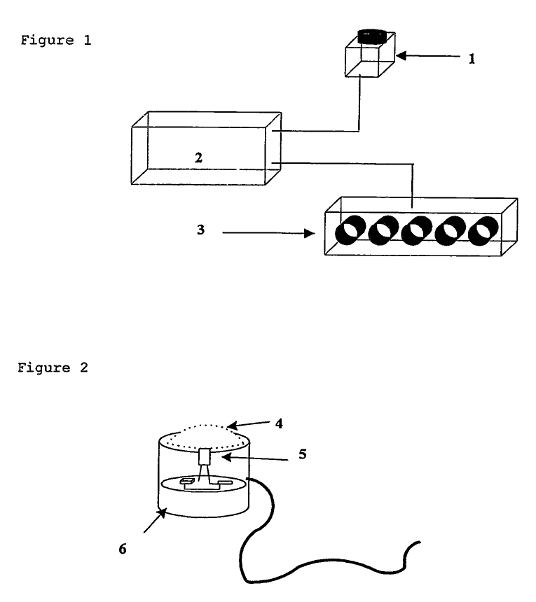

As shown in FIG. 1, the present invention may be composed of three modules, which are the sensor head (1), the electronic processing of the information (2), and the module to display the information (3).

The detector module (1) has an element that is able to detect the relevant UV radiation (UV-A or UV-B) from the sun and separate it from the visible or infrared radiation. This separation is made with the careful selection of detector element and filter.

The UV radiation that is relevant to detect is the one that causes harm to the skin.

This radiation is formulated using the International Commission on Illumination (CIE) reference action spectrum for UV-induced erythema on the human skin. It is a measure of the UV radiation that is relevant to the human health and is obtained by multiplying the UV radiation between 250 and 400 nm by the CIE erythema action spectrum shown in FIG. 4. According to the recommendation from the World Health Organization (WHO) any UV detector that measures the UV index has to use this method.

It is convenient to use a detector element that is not very sensible to visible or infrared radiation, such that not all separation is performed by the filter. An element that can be used as detector is a semiconductor material, because is has several ideal characteristics. One them is good chemical and mechanical stability, in addition, semiconductors are rugged and resistant to bumps, they prove not to have electrical signals in response to mechanical stress or hits. Accordingly, they should only give a signal in response to luminous stimulus, and be insensitive to materials present in the atmosphere, such as contaminants. The spectral response should also not vary in the presence of contaminants. Another advantage of semiconductors materials is that they can be manufactured in large numbers at low cost. Modern lithography techniques allow this kind of large-scale production.

The spectral response of the semiconductor detector should be approximately between 250 and 600 nanometers (nm). The spectral range of the ultraviolet radiation from the sun has a range between 250 and 400 nm, and the detector should at least have a similar range, but the detector should not have sensitivity beyond 600 nm. The intensity of the visible or infrared radiation from the sun is so high that it is very difficult for a filter to effectively block that radiation and allow the UV radiation to pass. Therefore, if the detector has low sensitivity to visible radiation and it is not sensitive to wavelengths larger than 600 nm, the filter does not need to be of very high quality and the cost can be kept low.

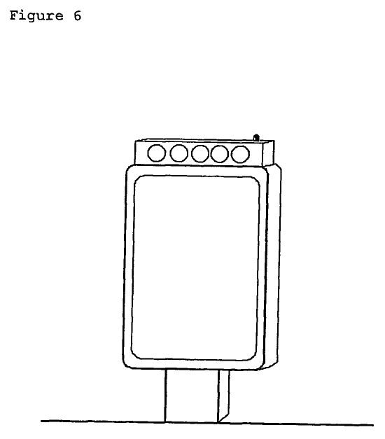

An example of the spectral response expected comes from a SiC detector as shown in FIG. 5. This material (SiC) has optical response only up to 400 nm, and the filter only has to block the radiation from 320 to 400 nm. The red line shows the spectral response of the SiC detector. The continuous line shows the spectral response of this detector in combination with a UV-B filter.

The intensity difference between the visible radiation (approximately 550 nm) and the UV radiation (300 nm) from the sun is about 1 million times (106). Because of this large difference, any detector that is sensible to visible radiation, should have a filter that has this type of relatonship between the “off” and “in” band. Most multiplayer narrow band-pass filters let radiation pass for the band that they have been designed and another band that has twice that wavelength (second harmonic). Consequently, a band pass filter centered at 300 nm always let some radiation pass in the 600 nm wavelength band. This radiation represents a source of noise that can give wrong values for the UV index. Because of this, for the present invention we have selected detectors with good response in the UV region, but low sensitivity to radiation with wavelengths longer than 600 nm. In order to measure the UV radiation in the UV-B range (280-320 nm), which is the band that is most dangerous to human health, the detector needs to have low sensitivity to visible radiation and couple it to a UV filter that blocks all radiation larger than 320 nm. FIG. 4, shows a detector with a filter that blocks all radiation larger than 330 nm.

The system and device of the present invention is composed of three parts: the head (1), an electronic circuit (2) and a display system (3) for the collected information.

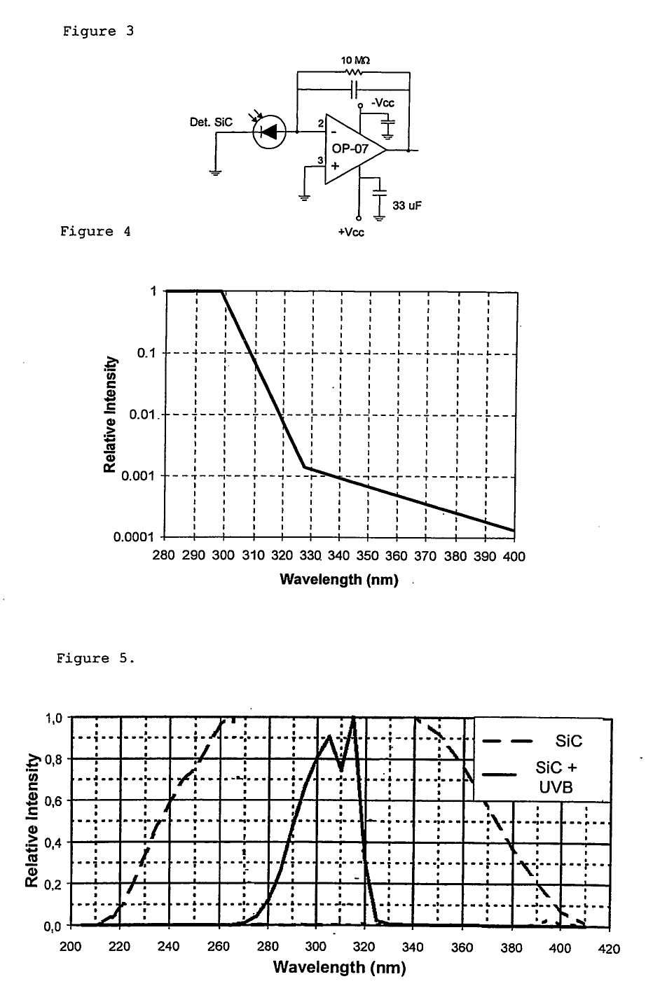

The head is composed of a semiconductor detector with a UV filter (see FIG. 2), a Teflon diffuser (4), an amplifier and a metallic enclosure (6) to minimize electronic interference. The Teflon diffuser (4) is used to integrate the UV radiation not coming directly from the sun, and to obtain a spatial cosine response. The head and the amplifier circuit are shown in FIG. 3. The active area of the detector should be larger than 1 mm², otherwise the amount of radiation detected is very small and a large amplification has to be realized. If the amplification is too large, then a lot of noise goes into the system and the accuracy is reduced.

The output of the head is an electrical signal that is proportional to the luminous intensity of the light in the UV range of interest; 280-320 nm for UV-B or 320-400 nm for UV-A. This electrical signal is fed to the electronic processing module. For example, the electronic processing module can give a signal from 0 to 100 mV, with 100 mV being an index 15, 0 mV being an index 0, and with a lineal response in between.

The electronic processing module receives the electrical signal from the head and converts into a signal that can be used by the display module. For example, if the electronic processing module gives 100 mV, where 100 mV is the maximum, the display module should turn on a signal corresponding to the maximum level (violet light). If the electronic processing module gives 0 mV, the display module should turn on a signal corresponding to the minimum level (green light). The electronic processing module should be able to amplify the signal if necessary. If the display module has colored lights to indicate the levels of the radiation, the electronic processing module should have switches (reles, triacs, etc) to turn on an off the lights when the radiation reaches certain preset values. If the display module uses colored flags to indicate the level of radiation, the electronic processing module should have motors to activate the flags when the radiation reaches certain preset values.

The amplification circuit shown in FIG. 3, has a standard transimpedance configuration. This configuration has low input impedance and allows a direct conversion of current from the detector into voltage. In the present invention, an OP-07, has been selected, because it has low variation in its parameters with temperature and because it has low noise. The feedback resistance has 10 megaOhm. It is necessary to use a high gain is the area of the detector is very small and does not detect much radiation; in addition, the Teflon diffuser stops about 60% of the incident radiation.

It is also possible to display the UV radiation level by means of a digital numeric display, a TV set, or other similar device that is used to display an electrical signal fitted to the place where the information needs to be displayed, either inside or outside.

The electronic circuit of the head shown in FIG. 3 corresponds to a preferred configuration for the present invention; however, such circuit can be replaced with other that has an equivalent performance.

### EXAMPLE OF APPLICATION

An example of an application of the present invention corresponds to a system that measures UV radiation such as the one shown in FIG. 6. A 5 color light set top display the intensity of UV radiation (“Solmáforo”) is included with a public advertisement. The color equivalency is the same as recommended and established by the World Health Organization (WHO), and that is present in the following table.

| Exposure | | |
|---|---|---|
| category | UV range | Color |
| Low | <2 | Green |
| Moderate | 3-5 | Yellow |
| High | 6-7 | Orange |
| Very high | 8-10 | Red |
| Extreme | >11 | Purple |

It has to be noted that the present invention is not restricted to the application of this example, because there are many other equivalent ways of displaying the UV information.

1. A system and its corresponding device to measure instantly and permanently the ultraviolet solar radiation, characterized in that it further comprises a device to display by means of colored lights (3), with preferably five different colored lights, for the indication of the instantaneous radiation measured and displayed in accordance with the recommendations, nomenclature, and correlation color index established by the World Health Organization (WHO); wherein the main means to detect comprises solid state electronics elements with a detector head having a semiconductor detector with a UV filter (5), a Teflon diffuser (4), an amplifier, and a metallic enclosure (6), wherein said amplifier has standard transimpedance configuration, preferably a low noise operational amplifier with a low sensitivity to temperature, wherein the detector head (1) is external and it is connected by means of a cable to the rest of the system.

2. The system according to claim 1, characterized in that it includes means to detect a signal that contains ultraviolet radiation, means for the processing of this signal, and means for the display of this processed signal to be visible from a distance in a place of public or private access.

3. The system according to claim 1, characterized in that it allows to detect the UV-B solar radiation by means of a filter added to the components mentioned in claim 1 such that the total spectral response corresponds to the erythema action curve.

4. The system according to claim 1, characterized in that the means to detect and process the information or data are solid state electronic elements.

5. A system and its corresponding device to measure instantly and permanently the ultraviolet solar radiation, characterized in that it comprises an ultraviolet detector head (1), which is electrically connected to an electronic processing unit of the received signal (2), which converts it to a display signal adequate to show the UV information in a public or private place by means of public ads, poster advertising, road boards, billboards, such that is clearly visible from a distance.

6. The device according to claim 5, characterized in that said display system is luminous, it can be located in any place of public or private access and it also can contain publicity or advertising.

7. The device according to claim 5, characterized in that the detector head has analog electronics and a circuit for analog to digital conversion.

8. The device according to claim 7, characterized in that the detector head comprises a semiconductor detector with an UV filter (5), a Teflon diffuser (4), an amplifier and a metallic enclosure (6).

9. The device according to claim 8, characterized in that said amplifier has a standard transimpedance configuration, preferentially a low noise operational amplifier with low sensitivity to temperature.

10. The device according to claim 5, characterized in that the means to display the ultraviolet radiation information mentioned consist of a set of five colored lights or leds array (3), colored flags, panels of liquid plasma/crystal TV, numeric indicators, or indicating panels of numbers and other similar means, the color equivalency being the same as recommended and established by the World Health Organization (WHO).

11. The device according to claim 10, characterized in that it is located in private places such as schools, private houses, swimming pools, stadiums or other similar places; wherein it displays by means of preferably five colors indicating the risk levels of the ultraviolet radiation according to the those established by the World Health Organization (WHO).

12. (canceled)
